(19) United States
(12) Patent Application Publication
(10) Pub. No.: US 2024/0323768 A1
(43) Pub. Date: Sep. 26, 2024

(54) NON-STANDALONE 5G SHARED RADIO ACCESS NETWORK MANAGEMENT

(71) Applicant: Apple Inc., Cupertino, CA (US)

(72) Inventors: Shangfeng LI, Beijing (CN); Zhiwei WANG, Beijing City (CN); Qiang MIAO, Beijing (CN); Li YAN, Kawakaki-Shi (JP); Ying ZHANG, Beijing (CN); Gaohong ZHOU, Beijing (CN)

(21) Appl. No.: 18/732,213

(22) Filed: Jun. 3, 2024

Related U.S. Application Data
(63) Continuation of application No. PCT/CN2021/136674, filed on Dec. 9, 2021.

(51) Int. Cl. H04W 36/00; H04W 36/30; H04W 88/06

(52) U.S. Cl. CPC H04W 36/00222; H04W 36/0058; H04W 36/30; H04W 88/06

(57) ABSTRACT

Embodiments described herein relate to managing access to 5G cellular baseband resources for 5G-capable wireless devices. A 5G-capable wireless device of an MNO, while connected to or camped on a legacy 4G LTE cell of the MNO and not engaged in a 4G only LTE service, determines whether an NSA 5G cell of another MNO satisfies performance criteria before measuring and/or sending measurement data for an NSA 4G LTE anchor cell associated with the NSA 5G cell to a wireless network. Refraining from measuring and/or sending measurement data under certain conditions causes the 5G-capable wireless device of the MNO to remain connected to or camped on the legacy 4G LTE cell of the MNO rather than reselecting or handing over to the NSA 4G LTE cell of another MNO. The 5G-capable wireless device also maintains a database of information for valid NSA 4G LTE cells to which to reselect/handover.

### CROSS-REFERENCE TO RELATED APPLICATIONS

The present application is a continuation of International Application PCT/CN2021/136674, with an international filing date of Dec. 9, 2021, of the same title, the contents of all of which are incorporated by reference herein in their entirety for all purposes.

### FIELD

The described embodiments relate to wireless communications, including methods and apparatus for managing access to fourth generation (4G) Long Term Evolution (LTE) anchor cells associated with fifth generation (5G) cellular baseband resources for 5G-capable wireless devices.

### BACKGROUND

Newer generation, e.g., fourth generation (4G) and fifth generation (5G), cellular wireless networks that implement one or more 3^{rd} Generation Partnership Project (3GPP) Long Term Evolution (LTE), LTE Advanced (LTE-A), and 5G standards are rapidly being developed and deployed by network operators worldwide. The newer cellular wireless networks provide a range of packet-based services, with 5G technology providing increased data throughput and lower latency connections that promise enhanced mobile broadband services for 5G-capable wireless devices. The higher data throughput and lower latency of 5G is expected to usher in a range of new applications and services as well as improve existing ones. A mobile network operator (MNO) can offset the cost of deploying new 5G cellular equipment by sharing access to 5G radio access networks (RANs) with one or more additional MNOs, and an additional MNO can offer access to 5G cellular service capabilities to its customers with lower upfront costs. The additional MNO can configure prioritization of RANs for a 5G-capable wireless device to camp on and/or connect to a non-standalone (NSA) 4G LTE anchor RAN, deployed by another MNO and shared with the additional MNO. The NSA 4G LTE anchor RAN is associated with an NSA 5G RAN to provide access to 5G cellular services for 5G-capable wireless devices. A legacy 4G LTE RAN of the additional MNO that does not offer access to 5G cellular services can have a lower prioritization. When the 5G-capable wireless device of the additional MNO measures 5G NSA RAN coverage as inadequate for 5G cellular service or connects to a 4G LTE cellular service, e.g., Voice over LTE (VOLTE), the 5G-capable wireless device can be redirected or handed over to the legacy 4G LTE RAN of the additional MNO. Prioritization can cause the 5G-capable wireless device to return to the 4G LTE anchor RAN, resulting in ping-pong transitions between the two different 4G LTE RANs. There exists a need for mechanisms to manage access to 4G LTE anchor cells associated with 5G cellular baseband resources based on a variety of factors.

### SUMMARY

This application relates to wireless communications, including methods and apparatus for managing access to 4G LTE anchor cells associated with 5G cellular baseband resources for 5G-capable wireless devices. A first mobile network operator (MNO) can deploy a non-standalone (NSA) 5G cellular wireless network by adding one or more NSA 5G radio access networks (RANs), also referred to herein as NSA 5G cells, associated with NSA 4G LTE anchor RANs, also referred to herein as NSA 4G LTE anchor cells. The first MNO can share the NSA 5G cells and NSA 4G LTE anchor cells with a second MNO for access to 5G cellular services for 5G-capable wireless devices associated with the second MNO. A 5G-capable wireless device of the first MNO can access 5G cellular services directly by adding the NSA 5G cell via a secondary cell group (SCG) function to interwork with a legacy 4G LTE cell of the first MNO or with the NSA 4G LTE anchor cell, one of which the 5G-capable wireless device of the first MNO can be connected to or camped on. A 5G-capable wireless device of the second MNO cannot access 5G cellular services when connected to or camped on a legacy 4G LTE cell of the second MNO. Instead, the 5G-capable wireless device of the second MNO can access 5G cellular services provided via an NSA 5G cell only when connected to or camped on the NSA 4G LTE anchor cell associated with the NSA 5G cell.

To allow for increased access to 5G cellular services for 5G-capable wireless devices associated with the first or second MNOs, a 5G-capable wireless device of the second MNO can be redirected or handed over from the NSA 4G LTE anchor cell of the first MNO to the legacy 4G LTE cell of the second MNO: i) when measurements of the NSA 5G cell associated with the NSA 4G LTE anchor cell indicate weak or no coverage for the 5G-capable cellular device of the second MNO and/or ii) when actively engaged in a 4G LTE only cellular service, e.g., a voice over LTE (VOLTE) call. When associated with the legacy 4G LTE cell of the second MNO, the 5G-capable wireless device of the second MNO can withhold taking and/or providing a measurement report for the NSA 4G LTE anchor cell until the associated NSA 5G cell is detectable and measurements of signal power, e.g., reference signal received power (RSRP) and/or signal quality, e.g., signal-to-noise-plus-interference ratio (SINR), exceed pre-determined threshold values. In some embodiments, the pre-determined threshold values can be configurable, e.g., by the 5G-capable wireless device or by a network entity. The 5G-capable wireless device of the second MNO can also withhold measurement and/or reporting for the NSA 4G LTE anchor cell while engaged in a 4G LTE only cellular service, e.g., no active VOLTE call. By withholding taking measurements and/or reporting measurements, the 5G-capable wireless device of the second MNO can remain connected to and/or camped on the legacy 4G LTE cell rather than reselect or handover to the NSA 4G LTE anchor cell. The 5G-capable wireless device of the second MNO can provide measurements for reselecting to the NSA 4G LTE anchor cell only when measurements of the NSA 5G cell associated with the NSA 4G LTE anchor cell satisfies the pre-determined thresholds. Thus, both the NSA 4G LTE anchor cell must satisfy reselection or handover criteria and the NSA 5G cell must satisfy additional criteria.

The 5G-capable wireless device of the second MNO can additionally maintain a database of information associated with NSA 4G LTE anchor cells of one or more MNOs, including but not limited to the first MNO. Each entry for an NSA 4G LTE anchor cell can include one or more of: a public land mobile network (PLMN) value, a tracking area code (TAC) value, an evolved universal mobile telecommunications system (UMTS) terrestrial radio access (E-UTRA) absolute radio frequency channel number (EARFCN) value, a physical cell identifier (PCI), a cell global identity (CGI), a related NSA 5G cell frequency, and a record time. The record time for the NSA 4G LTE anchor cell can represent the most recent time when the 5G-capable wireless device of the second MNO moved away from, e.g., disconnected from and/or de-camped from the NSA 4G LTE anchor cell. In some embodiments, the 5G-capable wireless device of the second MNO connects to and/or camps on a legacy 4G LTE cell of the second MNO. In some embodiments, a 5G mode of the 5G-capable wireless device is disabled (e.g., the 5G-capable wireless device reverts to functioning as a 4G LTE wireless device.) An entry for an NSA 4G LTE anchor cell can be added to the database maintained by the 5G-capable wireless device of the second MNO, if not already included in the database, when a system information broadcast (SIB) message, e.g., a SIB 1 message, indicates the NSA 4G LTE anchor cell has a shared PLMN configuration, and when an NSA 5G cell frequency for an NSA 5G cell associated with the NSA 4G LTE anchor cell is configured in a control message, e.g., in an RRC Connection Reconfiguration message, received by the 5G-capable wireless device of the second MNO. The 5G-capable wireless device of the second MNO can remove an NSA 4G LTE anchor cell from the database after being separated from (not connected to or camped on) the NSA 4G LTE anchor cell for longer than a pre-determined lifetime threshold value. In some embodiments, the lifetime threshold value can vary based on a mobility state of the 5G-capable wireless device of the second MNO. In some embodiments, higher mobility can be associated with lower lifetime threshold values, while lower mobility can be associated with higher lifetime threshold values. An NSA 4G LTE anchor cell included in the database can be considered a valid NSA 4G LTE anchor cell when a current time value minus the record time value stored for the NSA 4G LTE anchor cell is less than the lifetime threshold value.

Other aspects and advantages of the invention will become apparent from the following detailed description taken in conjunction with the accompanying drawings which illustrate, by way of example, the principles of the described embodiments.

This Summary is provided merely for purposes of summarizing some example embodiments so as to provide a basic understanding of some aspects of the subject matter described herein. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE DRAWINGS

The disclosure will be readily understood by the following detailed description in conjunction with the accompanying drawings, wherein like reference numerals designate like structural elements.

FIG. 1 illustrates a block diagram of different components of an exemplary system configured to implement cellular service provisioning to a wireless device, according to some embodiments.

FIG. 2 illustrates a block diagram of a more detailed view of exemplary components of the system of FIG. 1, according to some embodiments.

FIGS. 3A and 3B illustrate block diagrams of exemplary 5G non-standalone and standalone network architectures, according to some embodiments.

FIG. 4 illustrates a table summarizing examples of shared cellular wireless network architectures, according to some embodiments.

FIG. 5 illustrates a block diagram of exemplary actions to cause a mobile wireless device to gain or lose access to 5G cellular baseband resources, according to some embodiments.

FIG. 6A illustrates a block diagram of an exemplary set of actions to cause a 5G-capable mobile wireless device associated with a second MNO and in a connected state with a 4G LTE legacy cell to gain access to 5G cellular baseband resources of an NSA 5G cell associated with an NSA 4G LTE anchor cell of a first MNO, according to some embodiments.

FIG. 6B illustrates a block diagram of an exemplary set of actions to cause a 5G-capable mobile wireless device associated with a second MNO and camped on a 4G LTE legacy cell to gain access to 5G cellular baseband resources of an NSA 5G cell associated with an NSA 4G LTE anchor cell of a first MNO, according to some embodiments.

FIG. 7 illustrates an exemplary NSA 4G LTE anchor cell database maintained by a 5G-capable mobile wireless device, according to some embodiments.

FIGS. 8A and 8B illustrate flowcharts of an exemplary method performed by a 5G-capable mobile wireless device of a second MNO to control access to 5G cellular baseband resources of a first MNO, according to some embodiments.

FIG. 9 illustrates a block diagram of exemplary elements of a 5G-capable mobile wireless device, according to some embodiments.

### DETAILED DESCRIPTION

Representative applications of methods and apparatus according to the present application are described in this section. These examples are being provided solely to add context and aid in the understanding of the described embodiments. It will thus be apparent to one skilled in the art that the described embodiments may be practiced without some or all of these specific details. In other instances, well known process steps have not been described in detail in order to avoid unnecessarily obscuring the described embodiments. Other applications are possible, such that the following examples should not be taken as limiting.

This application relates to wireless communications, including methods and apparatus for managing access to 4G LTE anchor cells associated with 5G cellular baseband resources for 5G-capable wireless devices. To advance the availability of 5G, a mobile network operator (MNO) can deploy 5G radio access networks (RANs), also referred to herein as 5G cells, that interwork with existing 4G LTE radio access networks, also referred to herein as 4G LTE cells, and with an existing 4G LTE enhanced packet core (EPC) network in a non-standalone (NSA) configuration. A 5G-capable wireless device can connect to a 4G LTE RAN in a 4G mode, to a 5G RAN in a 5G mode, or to both the 4G LTE RAN and the 5G RAN in parallel. The 4G LTE and 5G RANs can interwork with each other via user plane and control plane connections. The 4G LTE EPC can provide control plane communication via the 4G LTE RAN to the 5G-capable wireless device. As the cost of deploying new 5G RANs can be substantial, multiple MNOs can agree to share access to 5G RAN installations to increase access to their subscribers. The MNOs can also maintain legacy 4G LTE RANs in parallel with the 5G NSA architecture to support 4G LTE only wireless devices or 5G-capable wireless devices that are using 4G LTE services, such as a Voice over LTE (VOLTE) service. An MNO can seek to prioritize availability of 5G resources, including associated 4G LTE RANs that interwork with 5G RANs, for 5G-capable wireless devices and move 4G LTE only wireless devices, as well as 5G-capable wireless devices actively using 4G LTE services, to legacy 4G LTE RANs. A legacy 4G LTE RAN controlled by a 4G LTE EPC of a second MNO can redirect or handover these same wireless devices to an NSA 4G LTE RAN controlled by a 4G LTE EPC of a first MNO. The resulting ping-pong movement of wireless devices between the 4G LTE RANs can increase control signaling unnecessarily and interfere with access to 5G resources. As described further herein, a 5G-capable wireless device can manage switching between 4G LTE RANs by maintaining a local database of information for NSA 4G LTE RANs.

A first mobile network operator (MNO) can deploy a non-standalone (NSA) 5G cellular wireless network by adding one or more NSA 5G radio access networks (RANs), also referred to as NSA 5G cells, associated with NSA 4G LTE anchor RANs, also referred to as NSA 4G LTE anchor cells. Each NSA 5G cell connects with at least one NSA 4G LTE anchor cell, and each of the NSA 5G and 4G LTE anchor cells connect with a 4G LTE EPC managed by the first MNO. The first MNO can share the NSA 5G cells and NSA 4G LTE anchor cells with a second MNO for access to 5G cellular services for 5G-capable wireless devices associated with the second MNO. The second MNO can maintain its own separate 4G LTE EPC network while sharing the NSA 5G and 4G LTE anchor cells. A 5G-capable wireless device of the first MNO can access 5G cellular services directly by adding the NSA 5G cell via a secondary cell group (SCG) function to interwork with i) an existing connection to or association with a legacy 4G LTE cell of the first MNO or ii) an existing connection to or association with the NSA 4G LTE anchor cell. A 5G-capable wireless device of the second MNO, however, cannot access 5G cellular services when connected to or camped on a legacy 4G LTE cell of the second MNO, as the legacy 4G LTE cell of the second MNO is connected to the 4G LTE EPC of the second MNO and not to the 4G LTE EPC of the first MNO to which the NSA 5G and 4G LTE anchor cells are connected. Instead, the 5G-capable wireless device of the second MNO can access 5G cellular services only when connected to or camped on the NSA 4G LTE anchor cell of the first MNO.

To allow for increased access to 5G cellular services for 5G-capable wireless devices associated with the first or second MNOs, a 5G-capable wireless device of the second MNO can be redirected or handed over from the NSA 4G LTE anchor cell to the legacy 4G LTE cell of the second MNO: i) when measurements of the NSA 5G cell indicate weak or no coverage for the 5G-capable cellular device of the second MNO and/or ii) when the 5G-capable cellular device of the second MNO is actively engaged in a 4G LTE only cellular service, e.g., a voice over LTE (VOLTE) call. In some embodiments, legacy 4G only wireless devices of the first MNO can be redirected or handed over from the NSA 4G LTE anchor cell of the first MNO to the legacy 4G LTE cell of the first MNO, while legacy 4G LTE only wireless device of the second MNO can be redirected or handed over from the NSA 4G LTE anchor cell of the first MNO to the legacy 4G LTE cell of the second MNO.

When associated with the legacy 4G LTE cell of the second MNO, a 5G-capable wireless device of the second MNO can refrain from taking and/or providing a measurement report for the NSA 4G LTE anchor cell, such as an A4 report, until i) an associated NSA 5G cell is detectable by the 5G-capable wireless device of the second MNO, and ii) measurements of signal power, e.g., reference signal received power (RSRP) and/or signal quality, e.g., signal-to-noise-plus-interference ratio (SINR), of the NSA 5G cell exceed pre-determined threshold values. In some embodiments, the pre-determined signal power and signal quality threshold values can be configurable, e.g., by the 5G-capable wireless device of the second MNO or by a network entity of the second MNO. In some embodiments, the pre-determined signal power and signal quality threshold values for the NSA 5G cell can be indicated by a network entity of the first MNO that deployed the NSA 5G cell. The 5G-capable wireless device of the second MNO can also withhold measurement and/or reporting for the NSA 4G LTE anchor cell while engaged in a 4G LTE only cellular service, e.g., during an active VOLTE call, and can perform measurements and/or report previously obtained measurements once use of the 4G LTE only cellular service has ended. By withholding the taking of measurements and/or reporting of measurements for the NSA 4G LTE anchor cell, the 5G-capable wireless device of the second MNO can remain connected to and/or camped on the legacy 4G LTE cell rather than be redirected or handed over to the NSA 4G LTE anchor cell. As also noted, the 5G-capable wireless device of the second MNO can provide measurements for reselecting to the NSA 4G LTE anchor cell only when measurements of the NSA 5G cell associated with the NSA 4G LTE anchor cell satisfies one or more pre-determined thresholds. Thus, both the NSA 4G LTE anchor cell must satisfy reselection criteria for the 5G-capable wireless device while in the idle state or measurement report criteria for the 5G-capable wireless device while in a connected state and the NSA 5G cell must satisfy additional criteria before the 5G-capable wireless device reports measurements (or takes measurements and then reports them) for the NSA 4G LTE anchor cell.

The 5G-capable wireless device of the second MNO can maintain a database of information associated with NSA 4G LTE anchor cells of one or more MNOs, including but not limited to NSA 4G LTE anchor cells of the first MNO. Each entry for an NSA 4G LTE anchor cell maintained by the 5G-capable wireless device of the second MNO can include one or more stored values, such as: i) a public land mobile network (PLMN) value, ii) a tracking area code (TAC) value, iii) an evolved universal mobile telecommunications system (UMTS) terrestrial radio access (E-UTRA) absolute radio frequency channel number (EARFCN) value, iv) a physical cell identifier (PCI) value, v) a cell global identity (CGI) value, vi) a related NSA 5G cell frequency, and vii) a record time. The record time for the NSA 4G LTE anchor cell maintained by the 5G-capable wireless device can represent a most recent time when the 5G-capable wireless device of the second MNO was connected to or camped on the NSA 4G LTE anchor cell and then subsequently disconnected from or de-camped from the NSA 4G LTE anchor cell. In some embodiments, the record time marks when the 5G-capable wireless device of the second MNO disconnects from (or de-camps from) the NSA 4G LTE anchor cell and connects to and/or camps on a legacy 4G LTE cell of the second MNO. In some embodiments, the record time indicates when a 5G mode of the 5G-capable wireless device is disabled (e.g., the 5G-capable wireless device reverts to functioning as a 4G LTE wireless device) and cannot establish a radio connection with the NSA 5G cell.

An entry for an NSA 4G LTE anchor cell can be added to the database maintained by the 5G-capable wireless device of the second MNO, if not already included in the database, when i) a system information broadcast (SIB) message, e.g., a SIB1 message, indicates the NSA 4G LTE anchor cell has a shared PLMN configuration, and when ii) an NSA 5G cell frequency for an NSA 5G cell associated with the NSA 4G LTE anchor cell is configured in a control message, e.g., an RRC Connection Reconfiguration message, received by the 5G-capable wireless device of the second MNO. The 5G-capable wireless device of the second MNO can remove an NSA 4G LTE anchor cell from the database after being separated from (not connected to or camped on) the NSA 4G LTE anchor cell for longer than a pre-determined lifetime threshold value. In some embodiments, the lifetime threshold value can vary based on a mobility state of the 5G-capable wireless device of the second MNO. In some embodiments, higher mobility can be associated with lower lifetime threshold values, while lower mobility can be associated with higher lifetime threshold values. When the 5G-capable wireless device of the second MNO is stationary (or effectively stationary, with translational movement less than a certain value), the lifetime threshold value(s) for 4G LTE anchor cells can be higher, allowing for keeping records in the database longer. When the 5G-capable wireless device of the second MNO is moving (with translational movement in certain value ranges, and/or at/above certain values), the lifetime threshold value(s) for 4G LTE anchor cells can be lower, allowing for purging records from the database more quickly. In some embodiments, the 5G-capable wireless device of the second MNO maintains a first lifetime threshold value for use when in a stationary state (at/below a first translational movement value), a second lifetime threshold value for use when in a slow-moving state (above the first and at/below a second translational movement value), and a third lifetime threshold value for use when in a fast-moving state (above the second translational movement value). More or fewer lifetime threshold values can also be used corresponding to different mobility states, e.g., values associated with stationary, pedestrian, bicycle, automobile, train, high-speed train, airplane, etc. modes. An NSA 4G LTE anchor cell included in the database can be considered a valid NSA 4G LTE anchor cell when a current time value minus the record time value stored for the NSA 4G LTE anchor cell is less than the lifetime threshold value. In some embodiments, the 5G-capable wireless device can refrain from connecting to or camping on an invalid NSA 4G LTE anchor cell.

In the following detailed description, references are made to the accompanying drawings, which form a part of the description and in which are shown, by way of illustration, specific embodiments in accordance with the described embodiments. Although these embodiments are described in sufficient detail to enable one skilled in the art to practice the described embodiments, it is understood that these examples are not limiting; such that other embodiments may be used, and changes may be made without departing from the spirit and scope of the described embodiments.

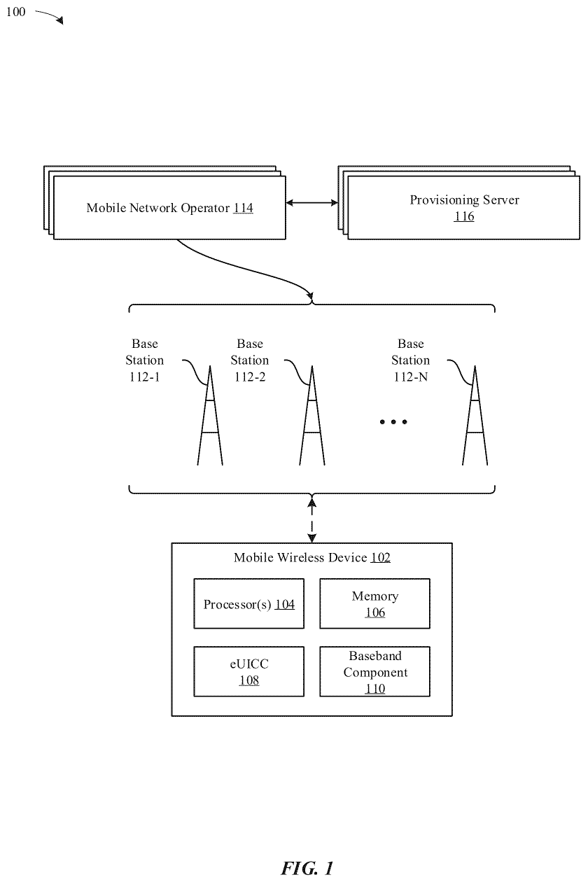

These and other embodiments are discussed below with reference to FIGS. 1 through 11; however, those skilled in the art will readily appreciate that the detailed description given herein with respect to these figures is for explanatory purposes only and should not be construed as limiting.

FIG. 1 illustrates a block diagram of different components of a system 100 that includes i) a mobile wireless device 102, which can also be referred to as a wireless device, a wireless communication device, a mobile device, a user equipment (UE), a device, and the like, ii) a group of base stations 112-1 to 112-N, which are managed by different Mobile Network Operators (MNOs) 114, and iii) a set of provisioning servers 116 that are in communication with the MNOs 114. The mobile wireless device 102 can represent a mobile computing device (e.g., an iPhone® or an iPad® by Apple®), the base stations 112-1 to 112-N can represent cellular wireless network entities including fourth generation (4G) Long Term Evolution (LTE) evolved NodeBs (eNodeBs or eNBs) and/or fifth generation (5G) NodeBs (gNodeBs or gNBs) that are configured to communicate with the mobile wireless device 102, and the MNOs 114 can represent different wireless service providers that provide specific services (e.g., voice and data) to which a user of the mobile wireless device 102 can subscribe to access the services via the mobile wireless device 102. Applications resident on the mobile wireless device 102 can advantageously access services using 4G LTE connections and/or 5G connections via the base stations 112. The mobile wireless device 102 can include processing circuitry, which can include one or more processors 104 and a memory 106, an embedded Universal Integrated Circuit Card (cUICC) 108, and a baseband component 110. In some embodiments, the mobile wireless device 102 includes one or more physical UICCs, also referred to as Subscriber Identity Module (SIM) cards (not shown), in addition to the eUICC 108. The components of the mobile wireless device 102 work together to enable the mobile wireless device 102 to provide useful features to a user of the mobile wireless device 102, such as cellular wireless network access, non-cellular wireless network access, localized computing, location-based services, and Internet connectivity. The cUICC 108 can be configured to store multiple electronic SIMs (eSIMs) for accessing services offered by one or more different MNOs 114 via communication through base stations 112-1 to 112-N. To be able to access services provided by the MNOs, one or more eSIMs can be provisioned to the eUICC 108 of the mobile wireless device 102. In some embodiments, policies associated with SIMs/eSIMs can determine whether a mobile wireless device 102 can access 5G services via 5G base stations 112.

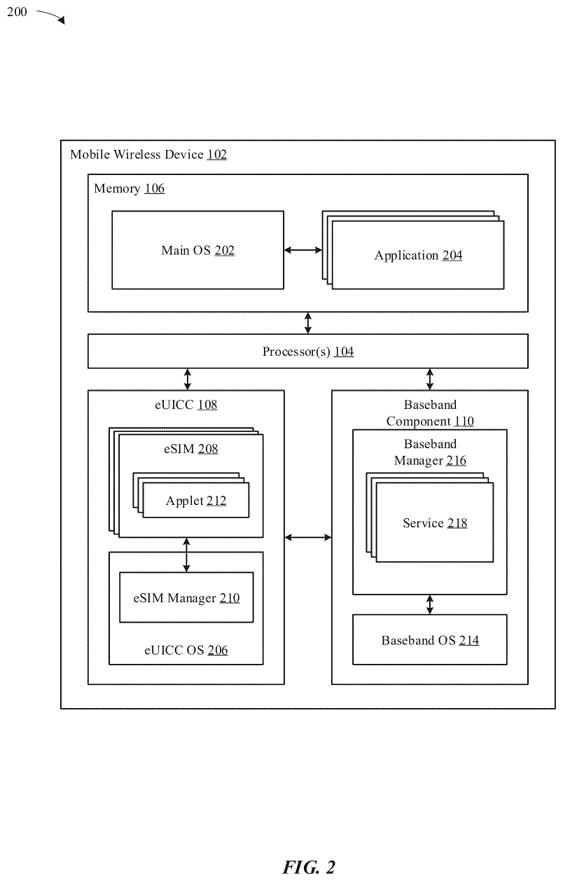

FIG. 2 illustrates a block diagram 200 of a more detailed view of exemplary components of the system 100 of FIG. 1. The one or more processors 104, in conjunction with the memory 106, can implement a main operating system (OS) 202 that is configured to execute applications 204 (e.g., native OS applications and user applications). The one or more processors 104 can include applications processing circuitry and, in some embodiments, wireless communications control circuitry. The applications processing circuitry can monitor application requirements and usage to determine recommendations about communication connection properties, such as bandwidth and/or latency, and provide information to the communications control circuitry to determine suitable wireless connections for use by particular applications. The communications control circuitry can process information from the applications processing circuitry as well as from additional circuitry, such as the baseband component 110, and other sensors (not shown) to determine states of components of the mobile wireless device 102, e.g., reduced power modes, as well as of the mobile wireless device 102 as a whole, e.g., mobility states. The communications control circuitry, in some embodiments, can also account for SIM/eSIM policies that influence whether an application or service of the mobile wireless device 102 can access particular RATs, such as access to 5G cellular connections. The communications control circuitry can provide control signals to the baseband component 110 to determine which RATs particular applications can access. The mobile wireless device 102 further includes an cUICC 108 that can be configured to implement an cUICC OS 206 to manage the hardware resources of the eUICC 108 (e.g., a processor and a memory embedded in the UICC 108). The cUICC OS 206 can also be configured to manage eSIMs 208 that are stored by the eUICC 108, e.g., by enabling, disabling, modifying, updating, or otherwise performing management of the cSIMs 208 within the cUICC 108 and providing the baseband component 110 with access to the eSIMs 208 to provide access to wireless services for the mobile wireless device 102. The cUICC OS 206 can include an cSIM manager 210, which can perform management functions for various cSIMs 208. Each eSIM 208 can include a number of applets 212 that define the manner in which the eSIM 208 operates. For example, one or more of the applets 212, when implemented by the baseband component 110 and the cUICC 108, can be configured to enable the mobile wireless device 102 to communicate with an MNO 114 and provide useful features (e.g., phone calls and internet) to a user of the mobile wireless device 102.

A baseband component 110 of the mobile wireless device 102 can include a baseband OS 214 that is configured to manage hardware resources of the baseband component 110 (e.g., a processor, a memory, different radio components, etc.). According to some embodiments, the baseband component 110 can implement a baseband manager 216 that is configured to interface with the eUICC 108 to establish a secure channel with a provisioning server 116 and obtaining information (such as cSIM data) from the provisioning server 116 for purposes of managing eSIMs 208. The baseband manager 216 can be configured to implement services 218, which represents a collection of software modules that are instantiated by way of the various applets 212 of enabled eSIMs 208 that are included in the cUICC 108. For example, services 218 can be configured to manage different connections between the mobile wireless device 102 and MNOs 114 according to the different cSIMs 208 that are enabled within the cUICC 108.

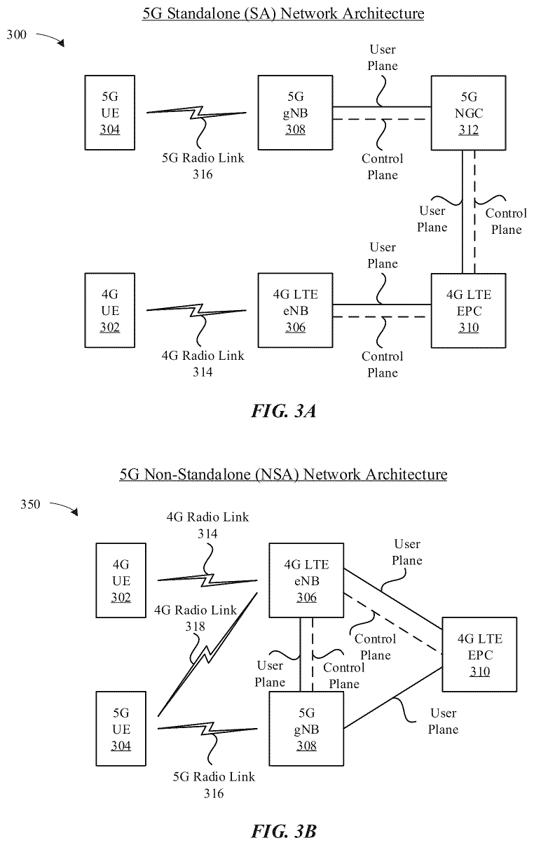

FIGS. 3A and 3B illustrate block diagrams 300, 350 of 5G standalone (SA) and non-standalone (NSA) network architectures respectively. Operating in a SA mode, as shown in FIG. 3A, a 5G user equipment (UE) 304 communicates with a cellular wireless network via a 5G radio link 316 to a 5G gNB (base station) 308, while a 4G UE 302 separately communicates with its own cellular wireless network via a 4G radio link 314 to a 4G LTE eNB 306. The 5G gNB 308 is connected to a 5G next generation core (NGC) network 312 including both a user plane connection for data transfer and a control plane connection for control signaling. Similarly, the 4G LTE eNB 306 is connected to a 4G LTE enhanced packet core (EPC) 310. The 4G LTE EPC 310 network can interwork with the 5G NGC 312 network via user plane and control connections between them. 5G SA networks that include both 5G access networks based on 5G gNBs 308 and a 5G NGC 312, however, are expected to take multiple years to build out, and as such a hybrid network that includes elements of both a 4G cellular wireless network and a 5G cellular wireless network is planned for 5G UEs 304 to operate in an NSA mode as illustrated by FIG. 3B. Operating in a NSA mode, a 5G UE 304 communicates with a cellular wireless network via both a 5G radio link 316 to a 5G gNB 308 and via a separate 4G radio link 318 to a 4G LTE eNB 306. The 4G LTE eNB 306 can be used for control plane signaling and act as a primary node for access network connection with the 5G UE 304, while the 5G gNB 308 can be used for user plane data transfer and act as a secondary node for access network connection with the 5G UE 304. The 5G gNB 308 can transfer user plane data to the 4G LTE EPC 310 when directly connected to the 4G LTE EPC 310 or when indirectly connected to the 4G LTE EPC 310 via the 4G LTE 3NB 306, as indicated by the user plane connection between the 4G LTE eNB 306 and the 5G gNB 308. A 4G UE 302 (or a 5G UE 304 operating in a 4G LTE mode) can connect to the 4G LTE eNB 306 via the 4G radio link 314 for both control signaling and user plane data transfer. 5G cellular wireless networks can offer higher data throughput speeds and lower latency data connections that will enhance existing services and applications while enabling new applications and services that take advantage of the improved performance 5G network.

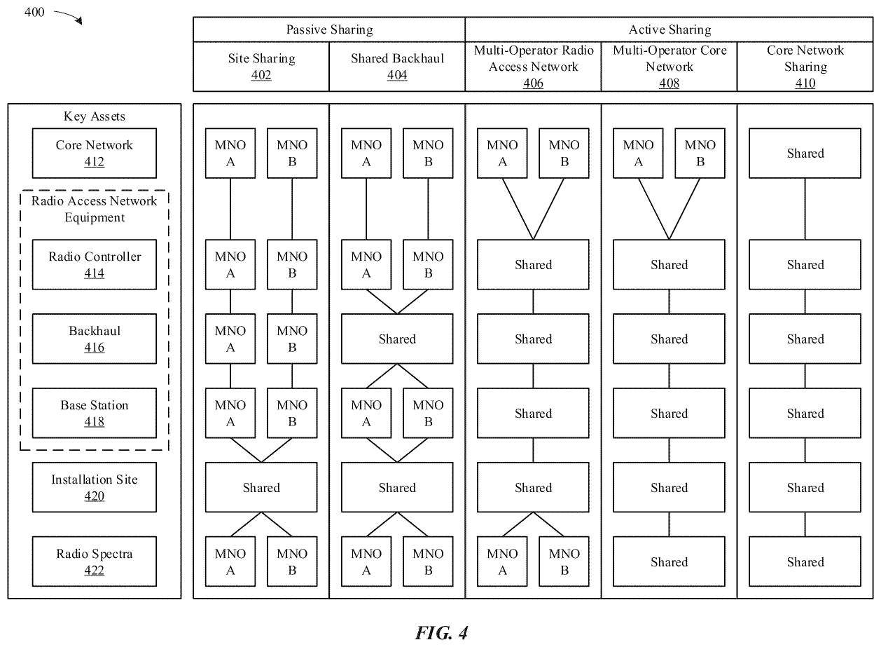

FIG. 4 illustrates a table 400 summarizing several different configurations for sharing cellular wireless network equipment between two different MNOs 114. The MNOs 114 can share key assets of a cellular wireless network in order to provide access to newer technology, such as to 5G cellular baseband resources deployed and managed by a first MNO 114, e.g., MNO A, to subscribers associated with a second MNO 114, e.g., MNO B. Given substantial cost to deploy new cellular radio technologies, MNOs A and B can agree to an arrangement in which 5G-capable wireless devices, e.g., 5G UEs 304, of MNO B can access 5G cellular baseband resources deployed by MNO A. Different architectures have been proposed for sharing one or more key assets of cellular wireless networks as illustrated in FIG. 4. Passive sharing arrangements provide for minimal infrastructure shared between MNOs 114, while active sharing arrangements enable cellular network equipment of various types to be shared between MNOs 114. In a site sharing 402 arrangement, two different MNOs 114, e.g., MNO A and MNO B, can maintain distinct cellular wireless equipment both at the core network 412 level and at the local radio access network (RAN) equipment level, with only one or more installation sites 420 to be shared between the MNOs 114. Each of the MNOs 114 can also use different radio frequency bands, indicated as radio spectra 422 in FIG. 4. In a shared backhaul arrangement 404, the MNOs 114 can additionally share backhaul connections 416 between their own radio controllers 414 and base stations 418. In a multi-operator radio access network 406 sharing arrangement, two different MNOs 114, e.g., MNO A and MNO B, can further share radio access network equipment, e.g., radio controllers 414, backhaul connections 416, and base stations 418, while maintaining separate radio spectra 422. In a multi-operator core network 408 arrangement, the two different MNOs 114 can further share a common radio spectrum 422. Finally, in a core network sharing 410 arrangement, the two distinct MNOs 114 can share core network 412 equipment. The techniques described herein focus on arrangements where two different MNOs 114 allow sharing of RAN equipment, so that mobile wireless devices 102 of a second MNO 114, e.g., MNO B, can gain access to 5G cellular baseband resources of a first MNO 114, e.g., MNO A.

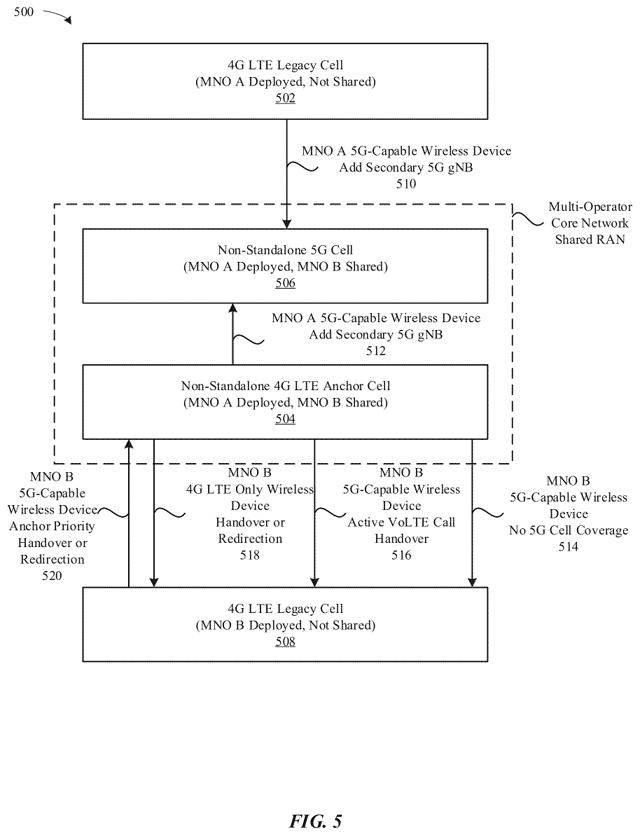

FIG. 5 illustrates a block diagram 500 of interconnected RANs (cells) of two different MNOs 114 that share access to an NSA 5G cell 506, deployed by MNO A and shared with MNO B, and an associated NSA 4G LTE anchor cell 504, also deployed by MNO A and shared with MNO B. Each of MNO A and MNO B also maintain their own distinct (non-shared) 4G LTE legacy cells 502, 508. A 5G-capable wireless device 102 associated with MNO A can gain access to 5G cellular baseband resources by adding the NSA 5G cell 506 using a secondary cell group (SCG) addition procedure, as indicated by the path 510. Similarly, a 5G-capable wireless device 102 associated with MNO A can also gain access to the 5G baseband resources of the NSA 5G cell 506 via a secondary cell group addition procedure, as indicated by the path 512. A 5G-capable wireless device 102 associated with MNO B can only access 5G baseband resources of the NSA 5G cell 506 by connected to or camping on the NSA 4G LTE anchor cell 504 of MNO A. When connected to the 4G LTE legacy cell 508, deployed by MNO B and not shared with MNO A, the 5G-capable wireless device 102 of MNO B will only have access to 4G LTE services. Cell reselection/handover prioritization for the 5G-capable wireless device 102 of MNO B can cause the 5G-capable wireless device 102 to handover (when connected) or be redirected (when in an idle state) from the 4G LTE legacy cell 508 of MNO B to the NSA 4G LTE anchor cell 504 of MNO A in order to gain access to the NSA 5G cell 506 baseband resources, as indicated by the path 520. In some circumstances, the 5G-capable wireless device 102 of MNO B can be handed over or redirected back to the 4G LTE legacy cell 508 from the NSA 4G LTE anchor cell 504. When the 5G-capable wireless device 102 of MNO B is actively engaged in a 4G only cellular service, such as while on an active voice over LTE (VOLTE) call, the 5G-capable wireless device 102 of MNO B can be handed over to the 4G LTE legacy cell for at least the duration of the VOLTE call, as indicated by path 516. When reception of the NSA 5G cell 506 by the 5G-capable wireless device 102 of MNO B falls below a threshold performance level, where the 5G-capable wireless device 102 of MNO B is unable to access 5G baseband resources of the NSA 5G cell 506, the 5G-capable wireless device 102 of MNO B can also be handed over or redirected from the NSA 4G LTE anchor cell 504 to the 4G LTE legacy cell 508. Additionally, MNO A can seek to prioritize access to the NSA 4G LTE anchor cell to 5G-capable devices 102, while 4G-only devices 102 of MNO B can be redirected or handed over from the NSA 4G LTE anchor cell 504 to the 4G LTE legacy cell 508, as indicated by path 518, to free up resources of the NSA 4G LTE anchor cell for 5G-capable devices 102. In some cases, the 4G LTE legacy cell 508 and the NSA 4G LTE anchor cell can share a similar prioritization level, e.g., a lowest prioritization level. In some cases, the NSA 4G LTE anchor cell 504 can have a lower priority than the 4G LTE legacy cell 508 for 4G-only devices 102 of MNO B. In some cases, the NSA 4G LTE anchor cell 504 can have a higher priority than the 4G LTE legacy cell 508 based on prioritizations set by MNO B for 5G-capable devices 102 of MNO B, while MNO A can de-prioritize access to the NSA 4G LTE anchor cell 504 for 5G-capable devices of MNO B when they are engaged in a 4G LTE service or have weak or no coverage for access to the NSA 5G cell 506. Without further management, 5G-capable devices 102 of MNO B can be handed over or redirected back and forth between the 4G LTE legacy cell 508 and the NSA 4G LTE anchor cell 504. For example, a 5G-capable wireless device 102 of MNO B can be connected to or camped on the NSA 4G LTE anchor cell 504 of MNO A and be handed over or redirected by the wireless network of MNO A to the 4G LTE legacy cell 508 of MNO B when the signal strength and/or quality of the NSA 5G cell 506 is weak, where measurements of the NSA 5G cell 506 can be reported by the 5G-capable device 102 of MNO B to the wireless network of MNO A. The wireless network of MNO B, however, can prioritize the 5G-capable wireless device 102 of MNO B to switch back from the 4G LTE legacy cell 508 of MNO B back to the NSA 4G LTE anchor cell 504 of MNO A. As a result of the handovers/redirections, the 5G-capable wireless device 102 of MNO B can ping-pong between the two different 4G LTE cells of the two different wireless networks of MNO A and MNO B. In another example, a 5G-capable wireless device 102 of MNO B participating in a 4G LTE service, such as a VOLTE call, while connected to the NSA 4G LTE anchor cell 504 of MNO A can be redirected to the 4G LTE legacy cell 508 of MNO B. The wireless network of MNO B can prioritize the 5G-capable wireless device 102 of MNO B to switch from the 4G LTE legacy cell 508 of MNO B back to the NSA 4G LTE anchor cell 504 of MNO A.

To forestall such ping-pong behavior between 4G cells 504, 508, as discussed further herein, a 5G-capable wireless device 102 of MNO B can manage communication with the cellular network to reduce the movement between the 4G cells, while still permitting access to 5G baseband resources when applicable. The 5G-capable wireless device 102 of MNO B can maintain a database of one or more NSA 4G LTE anchor cells 504 including radio frequencies of associated NSA 5G cells 506. When the 5G-capable wireless device 102 of MNO B is camped on or connected to a 4G LTE legacy cell 508, the 5G-capable wireless device 102 of MNO B can withhold a measurement report, e.g., an A4 report, for an NSA 4G LTE anchor cell 504 associated with another MNO, e.g., MNO A, under certain circumstances, e.g., while engaged in an active 4G only service, such as on a VOLTE call, and/or when a signal strength and/or quality of an NSA 5G cell 506 associated with the NSA 4G LTE anchor cell 504 does not meet one or more performance thresholds. In some embodiments, the 5G-capable wireless device 102 of MNO B can perform and/or report measurements, such as A4 measurements, of an NSA 4G LTE anchor cell 504 associated with another MNO, e.g., MNO A, only when measurements of an associated NSA 5G cell 506 satisfies one or more performance thresholds, such as a signal power threshold, a signal quality threshold, a signal-to-noise-plus-interference threshold, etc.

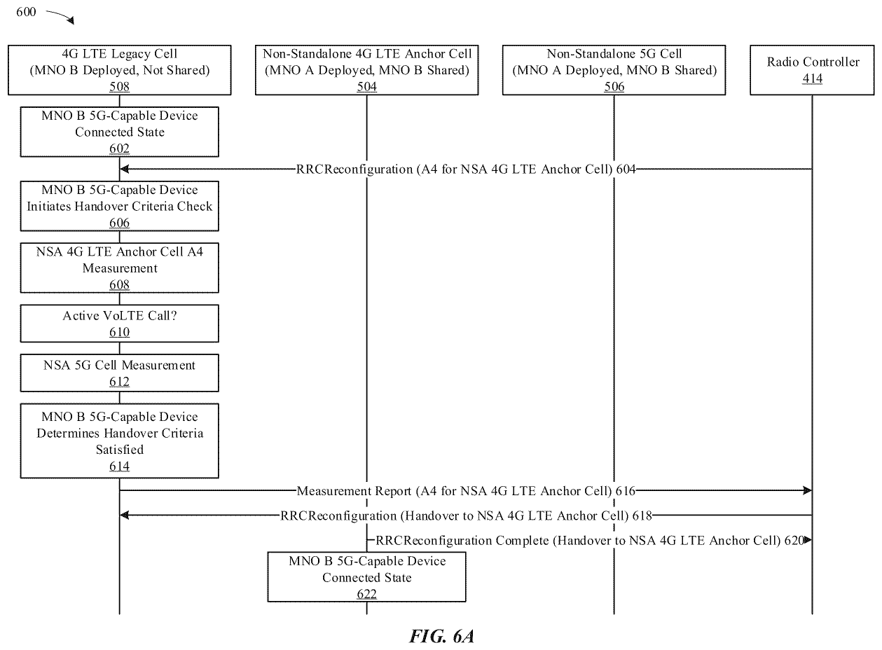

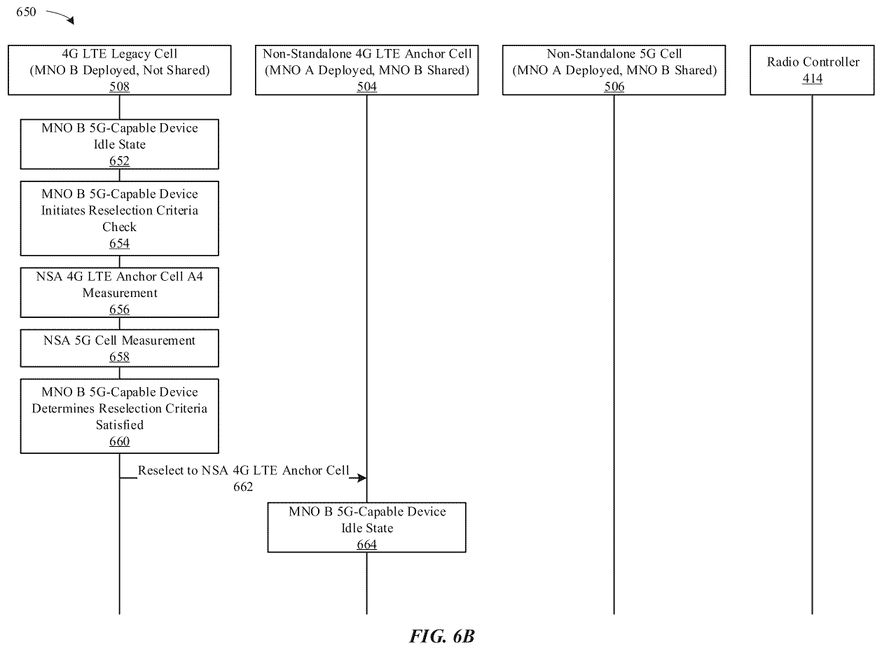

FIG. 6A illustrates a block diagram 600 of an exemplary set of actions to cause a 5G-capable wireless device 102 associated with a second MNO, e.g., MNO B, and in a connected state with a 4G LTE legacy cell 508 of the second MNO to gain access to 5G cellular baseband resources of an NSA 5G cell 506 associated with an NSA 4G LTE anchor cell 504 of a first MNO, e.g., MNO A. At 602, the 5G-capable wireless device 102 of MNO B is connected to a 4G LTE legacy cell 508 of MNO B that is deployed by MNO B and not shared with MNO A. At 604, the 5G-capable wireless device 102 receives from a network entity, e.g., a radio controller 414, a control message, e.g., an RRC Reconfiguration message, that indicates information for measurement of the NSA 4G LTE anchor cell 504 of MNO A, e.g., for an A4 measurement. At 606, the 5G-capable wireless device 102 initiates a procedure to check performance criteria for handover. At 608, the 5G-capable wireless device 102 executes a performance measurement of the NSA 4G LTE anchor cell 504 of MNO A indicated in the control message received from the network entity. At 610, the 5G-capable wireless device 102 determines whether it is currently engaged in a 4G LTE only service, such as in an active VOLTE call. At 612, the 5G-capable wireless device 102 executes a performance measurement of an NSA 5G cell 506 of MNO A associated with the NSA 4G LTE anchor cell 504 of MNO A. At 614, the 5G-capable wireless device 102 determines that one or more handover criteria are satisfied. At 616, the 5G-capable wireless device 102 provides to the network entity, e.g., the radio controller 414, a measurement report, such as an A4 report, for the NSA 4G LTE anchor cell 504. When at least one of the one or more handover criteria are not satisfied, the 5G-capable wireless device 102 can withhold providing the measurement report to the network entity. By withholding the measurement report, the 5G-capable wireless device 102 can forestall handover from the 4G LTE legacy cell 508 to the NSA 4G LTE anchor cell 504 of MNO A. After sending the measurement report, at 618, the 5G-capable wireless device 102 receives from the network entity a control message, such as an RRC Reconfiguration message, to cause the 5G-capable wireless device 102 of MNO B to be handed over from the 4G LTE legacy cell 508 of MNO B to the NSA 4G LTE anchor cell 504 of MNO A. At 620, the 5G-capable wireless device 102 of MNO B can send a second control message, e.g., an RRC Reconfiguration Complete message to the network entity, e.g., to the radio controller 414, to indicate that handover to the NSA 4G LTE anchor cell 504 of MNO A is complete. At 622, the 5G-capable wireless device 102 of MNO B is connected to the NSA 4G LTE anchor cell 504 of MNO A. The 5G-capable wireless device 102 of MNO B, as a result of the handover, can have access to 5G baseband resources of MNO A of the NSA 5G cell 506 of MNO A while connected to (or subsequently camped on) the NSA 4G LTE anchor cell 504 of MNO A. For example, the 5G-capable wireless device 102 of MNO B can establish a second radio connection with the NSA 5G cell 506 of MNO A in parallel with a first radio connect to the NSA 4G LTE anchor cell 504 of MNO A.

The 5G-capable wireless device 102 of MNO B can perform the three actions at 608, 610, and 612 in a different order than indicated, e.g., in any possible order. In some embodiments, the 5G-capable wireless device 102 can determine whether the 5G-capable wireless device 102 is engaged in a 4G LTE only service, such as whether engaged in a VOLTE call, as a first action and when engaged in the 4G LTE only service refrain from performing measurements of the NSA 4G LTE anchor cell 504 and of the NSA 5G cell 506. In some embodiments, the 5G-capable wireless device 102 can perform measurement of the NSA 5G cell 506 as a first action, and determine whether the NSA 5G cell 506 satisfies one or more performance criteria, and when the NSA 5G cell 506 does not satisfy at least one of the one or more performance criteria, refrain from performing measurement of the NSA 4G LTE anchor cell 504 and/or of determining whether the 5G-capable wireless device 102 is engaged in a 4G LTE only service. In some embodiments, the 5G-capable wireless device 102 performs the actions of 608, 610, and 612 in any order, and checks after each action whether to proceed with performing the remaining actions based on the result of the action. In some embodiments, the 5G-capable wireless device 102 performs all three actions of 608, 610, and 612 regardless of results of any particular action. In some embodiments, the 5G-capable wireless device 102 only performs and/or reports measurement results for the NSA 4G LTE anchor cell 504 only i) when not engaged in a 4G LTE only service and ii) after performing and confirming measurement results for the NSA 5G cell 506 satisfy associated performance criteria. Representative performance criteria can include i) a measured signal strength, such as a reference signal received power (RSRP), satisfying a signal strength threshold and/or ii) a measured signal quality, such as a signal-to-noise-plus-interference ratio (SINR), satisfying a signal quality threshold. Satisfying a threshold can include a measured level meeting and/or exceeding the threshold.

FIG. 6B illustrates a block diagram 650 of an exemplary set of actions to cause a 5G-capable wireless device 102 associated with a second MNO, e.g., MNO B, camped on a 4G LTE legacy cell 508 of the second MNO, while in an idle state, to gain access to 5G cellular baseband resources of an NSA 5G cell 506 associated with an NSA 4G LTE anchor cell 504 of a first MNO, e.g., MNO A. At 652, the 5G-capable wireless device 102 of MNO B is in an idle state on the 4G LTE legacy cell 508 of MNO B. At 654, the 5G-capable wireless device 102 initiates a procedure to check reselection criteria to determine whether to remain on the 4G LTE legacy cell 508 of MNO B or to reselect to another cell, such as to the NSA 4G LTE anchor cell 504 deployed by MNO A and shared with MNO B. At 656, the 5G-capable wireless device 102 executes a performance measurement of the NSA 4G LTE anchor cell 504 of MNO A, e.g., an A4 measurement. At 658, the 5G-capable wireless device 102 executes a performance measurement of an NSA 5G cell 506 of MNO A associated with the NSA 4G LTE anchor cell 504 of MNO A. At 660, the 5G-capable wireless device 102 determines that one or more reselection criteria are satisfied based at least in part on the measurements performed at 656 and 658. At 662, the 5G-capable wireless device 102 reselects from the 4G LTE legacy cell 508 of MNO B to the NSA 4G LTE anchor cell 504 of MNO A. At 664, the 5G-capable wireless device 102 of MNO B is camped on the NSA 4G LTE anchor cell 504 of MNO A with access to 5G baseband resources of the NSA 5G cell 506 of MNO A. The measurements of the NSA 4G LTE anchor cell 504 and NSA 5G cell 506 can be performed in any order. In some embodiments, the 5G-capable wireless device 102 performs measurements of one of the NSA 4G LTE anchor cell 504 and NSA 5G cell 506 and checks whether the measured cell satisfies associated performance criteria and only continues to measure the other cell when the first measured cell satisfies its associated performance criteria. Representative performance criteria can include i) a measured signal strength, such as a reference signal received power (RSRP), satisfying a signal strength threshold and/or ii) a measured signal quality, such as a signal-to-noise-plus-interference ratio (SINR), satisfying a signal quality threshold. Satisfying a threshold can include a measured level meeting and/or exceeding the threshold.

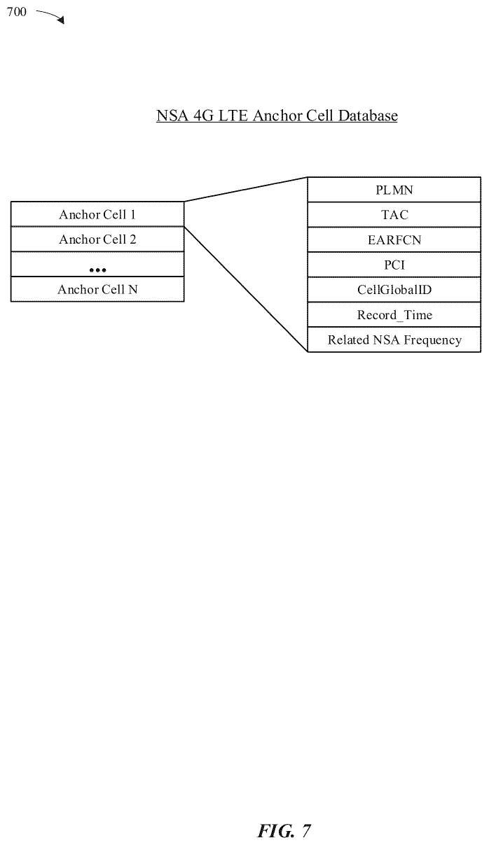

FIG. 7 illustrates an exemplary database 700 of NSA 4G LTE anchor cells 504 that a 5G-capable wireless device 102 associated with an MNO, e.g., MNO B, can maintain for various other MNOs that have NSA 5G cells 506 that can be shared with the 5G-capable wireless device 102. The 5G-capable wireless device 102 can maintain a list of NSA 4G LTE anchor cells 504, each entry in the list including information regarding a particular NSA 4G LTE anchor cell 504. The information can include values stored in one or more fields, such as: i) a public land mobile network (PLMN) value, ii) a tracking area code (TAC) value, iii) an evolved universal evolved mobile telecommunications system (UMTS) terrestrial radio access (E-UTRA) absolute radio frequency channel number (EARFCN) value, iv) a physical cell identifier (PCI) value, v) a cell global identity (CGI) value, vi) a related NSA 5G cell frequency, and vii) a record time. The record time for the NSA 4G LTE anchor cell 504 maintained by the 5G-capable wireless device 102 can represent a most recent time when the 5G-capable wireless device 102 was connected to or camped on the NSA 4G LTE anchor cell 504 and then subsequently disconnected from or reselected away from the NSA 4G LTE anchor cell 504. In some embodiments, the record time marks when the 5G-capable wireless device 102 disconnects from (or reselects away from) the NSA 4G LTE anchor cell 504 and connects to and/or camps on a 4G LTE legacy cell 508 of MNO B. In some embodiments, the record time indicates when a 5G mode of the 5G-capable wireless device 102 is disabled (e.g., the 5G-capable wireless device 102 reverts to functioning as a 4G LTE wireless device) and cannot establish a radio connection with the NSA 5G cell 506.

An entry for an NSA 4G LTE anchor cell 504 can be added to the database 700 maintained by the 5G-capable wireless device 102, if not already included in the database 700, when i) a system information broadcast (SIB) message, e.g., a SIB1 message, indicates the NSA 4G LTE anchor cell 504 has a shared PLMN configuration, and when ii) an NSA 5G cell frequency for an NSA 5G cell 506 associated with the NSA 4G LTE anchor cell 504 is configured in a control message, e.g., an RRC Connection Reconfiguration message, received by the 5G-capable wireless device 102. The 5G-capable wireless device 102 can remove an NSA 4G LTE anchor cell 504 from the database 700 after being separated from (not connected to or camped on) the NSA 4G LTE anchor cell 504 for longer than a pre-determined lifetime threshold value. In some embodiments, the lifetime threshold value can vary based on a mobility state of the 5G-capable wireless device 102. In some embodiments, higher mobility can be associated with lower lifetime threshold values, while lower mobility can be associated with higher lifetime threshold values. When the 5G-capable wireless device 102 is stationary (or effectively stationary, with translational movement less than a certain value), the lifetime threshold value(s) for NSA 4G LTE anchor cells 504 can be higher, allowing for keeping records in the database 700 longer. When the 5G-capable wireless device 102 is moving (with translational movement in certain value ranges, and/or at/above certain values), the lifetime threshold value(s) for NSA 4G LTE anchor cells 504 can be lower, allowing for purging records from the database 700 more quickly. In some embodiments, the 5G-capable wireless device 102 maintains a first lifetime threshold value for use when in a stationary state (at/below a first translational movement value), a second lifetime threshold value for use when in a slow-moving state (above the first and at/below a second translational movement value), and a third lifetime threshold value for use when in a fast-moving state (above the second translational movement value). Move or fewer lifetime threshold values can also be used corresponding to different mobility states, e.g., stationary, pedestrian, bicycle, automobile, train, airplane, etc. modes. An NSA 4G LTE anchor cell 504 included in the database 700 can be considered a valid NSA 4G LTE anchor cell 504 when a current time value minus the record time value stored for the NSA 4G LTE anchor cell 504 is less than the lifetime threshold value. In some embodiments, the 5G-capable wireless device 102 can refrain from connecting to or camping on an invalid NSA 4G LTE anchor cell 504.

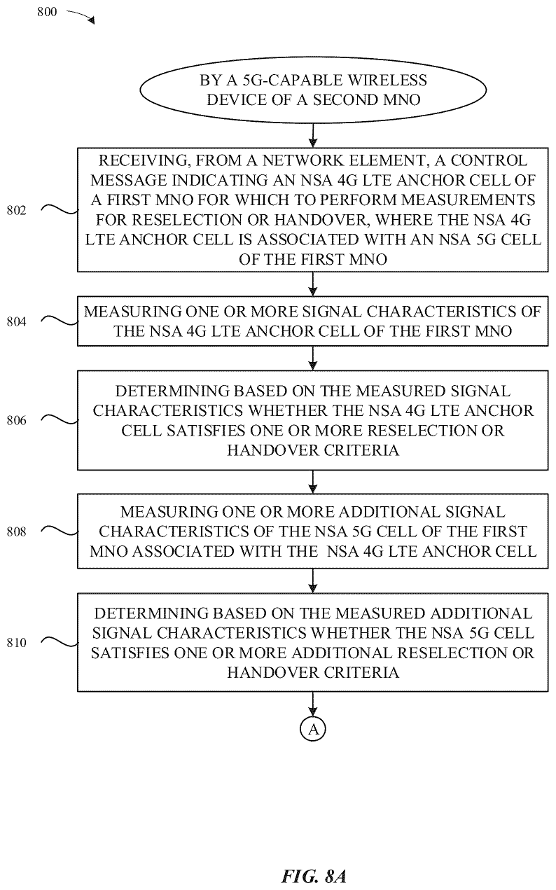

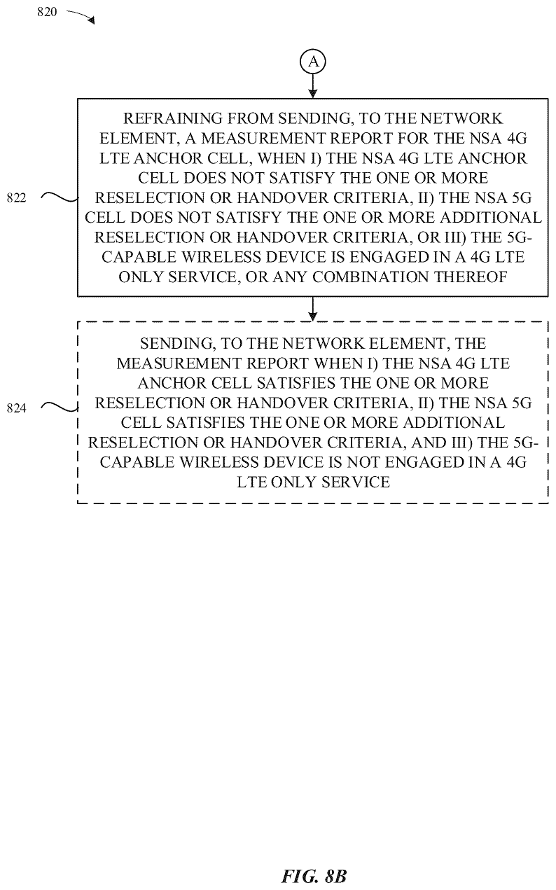

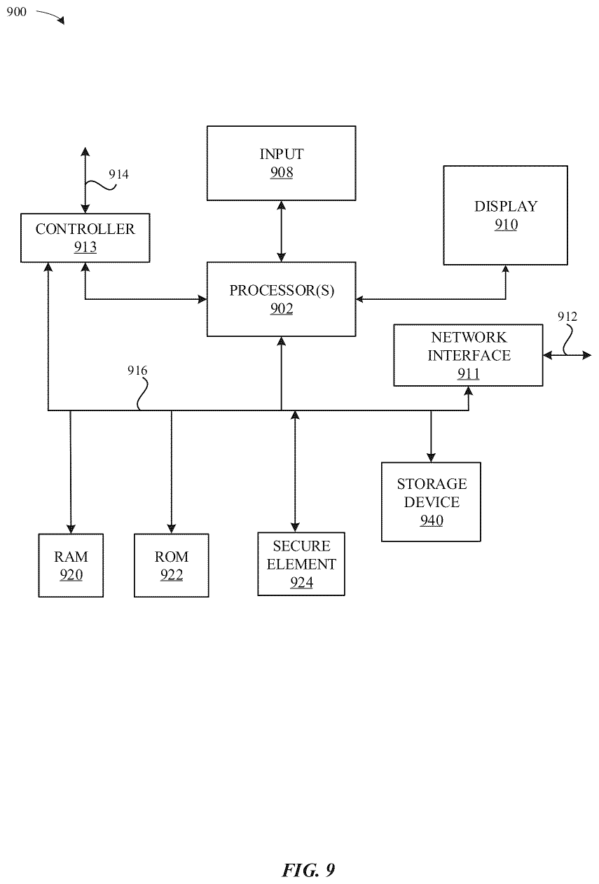

FIGS. 8A and 8B illustrate flowcharts 800, 820 of an exemplary method to control access to 5G cellular baseband resources by a mobile wireless device 102, e.g., a 5G-capable wireless device 102, while the 5G-capable wireless device 102 is connected to or camped on a legacy 4G cell of a second MNO 114. At 802, the 5G-capable wireless device 102 receives, from a network element, a control message indicating an NSA 4G LTE anchor cell 504 of a first MNO 114 for which to perform measurements for reselection or handover, where the NSA 4G LTE anchor cell 504 is associated with an NSA 5G cell 506 of the first MNO 114. At 804, the 5G-capable wireless device 102 measures one or more signal characteristics of the NSA 4G LTE anchor cell 504 of the first MNO 114. At 806, the 5G-capable wireless device determines, based on the measured signal characteristics, whether the NSA 4G LTE anchor cell 504 of the first MNO 114 satisfies one or more reselection or handover criteria. At 808, the 5G-capable wireless device 102 measures one or more additional signal characteristics of the NSA 5G cell of the first MNO 114 associated with the NSA 4G LTE anchor cell 504. At 810, the 5G-capable wireless device 102 determines, based on the measured additional signal characteristics, whether the NSA 5G cell 506 satisfies one or more additional reselection or handover criteria. At 822, the 5G-capable wireless device 102 refrains from sending, to the network element, a measurement report for the NSA 4G LTE anchor cell 504 when i) the NSA 4G LTE anchor cell 504 does not satisfy the one or more reselection or handover criteria, ii) the NSA 5G cell 506 does not satisfy the one or more additional reselection or handover criteria, or iii) the 5G-capable wireless device is engaged in a 4G LTE only service, or any combination thereof. In some embodiments, at 824, when i) the NSA 4G LTE anchor cell 504 satisfies the one or more reselection or handover criteria, ii) the NSA 5G cell 506 satisfies the one or more additional reselection or handover criteria, and iii) the 5G-capable wireless device is not engaged in a 4G LTE only service, the 5G-capable wireless device 102 sends to the network element the measurement report for the NSA 4G LTE anchor cell 504.

In some embodiments, the 5G-capable wireless device 102 receives, from the network element responsive to the measurement report, a second control message directing the 5G-capable wireless device 102 to reselect or handover to the NSA 4G LTE anchor cell 504, and the 5G-capable wireless device 102 reselects or performs a handover procedure to transfer from the 4G LTE legacy cell 508 of the second MNO to the NSA 4G LTE anchor cell 504 of the first MNO 114. In some embodiments, the 5G-capable wireless device 102 of the second MNO 114 is engaged in a 4G LTE only service while connected on an active voice over LTE (VOLTE) call. In some embodiments, the 5G-capable wireless device 102 of the second MNO 114 receives, from a second network element, a broadcast message indicating the NSA 4G LTE anchor cell 504 is configured to share access with the second MNO 114. In some embodiments, the 5G-capable wireless device 102 of the second MNO 114 receives, from the network element, a second control message indicating a radio frequency of the NSA 5G cell 506. In some embodiments, the 5G-capable wireless device 102 of the second MNO 114 maintains a database 700 of NSA 4G LTE anchor cells 504 in local storage of the 5G-capable wireless device 102 and updates a record time for a particular NSA 4G LTE anchor cell 504 included in the database 700, the record time indicating a most recent time that the 5G-capable wireless device 102 disconnected from or reselected away from the particular NSA 4G LTE anchor cell 504. In some embodiments, the 5G-capable wireless device 102 of the second MNO 114 adds an entry for an additional NSA 4G LTE anchor cell 504 to the database 700 when not already included in response to receipt of i) a broadcast message indicating the additional NSA 4G LTE anchor cell 504 is configured to share access with the second MNO 114 and of ii) a control message indicating a radio frequency of an additional NSA 5G cell 506 associated with the additional NSA 4G LTE anchor cell 504. In some embodiments, the database 700 includes for each entry one or more fields storing values including: i) a public land mobile network (PLMN) value, ii) a tracking area code (TAC) value, iii) an evolved universal evolved mobile telecommunications system (UMTS) terrestrial radio access (E-UTRA) absolute radio frequency channel number (EARFCN) value, iv) a physical cell identifier (PCI), v) a cell global identity (CGI), vi) a related NSA 5G cell 506 radio frequency, and vii) the record time for the associated NSA 4G LTE anchor cell 504. In some embodiments, the 5G-capable wireless device 102 of the second MNO 114 deletes an entry for an associated NSA 4G LTE anchor cell 504 from the database 700 when a current time minus the record time for the associated NSA 4G LTE anchor cell 504 exceeds a lifetime threshold value. In some embodiments, the lifetime threshold value is based at least in part on a mobility state of the 5G-capable wireless device 102 of the second MNO 114. In some embodiments, the 5G-capable wireless device 102 of the second MNO 114 adjusts the lifetime threshold value to a lower value when the 5G-capable wireless device 102 of the second MNO 114 is moving and to a higher value when the 5G-capable wireless device 102 of the second MNO 114 is stationary.

In some embodiments, an apparatus configurable for operation in a 5G-capable wireless device 102 of a second MNO 114 includes one or more processors coupled to a memory storing instructions that, when executed by the one or more processors, cause the 5G-capable wireless device 102 of the second MNO 114 to perform actions for controlling access to 5G cellular baseband resources of a first MNO 114, where the actions include: while connected to or camped on a 4G LTE legacy cell 508 of the second MNO 114: i) receiving, from a network element, a control message indicating a non-standalone (NSA) 4G LTE anchor cell of the first MNO for which to perform measurements for reselection or handover, the NSA 4G LTE anchor cell associated with an NSA 5G cell of the first MNO; ii) measuring one or more signal characteristics of the NSA 4G LTE anchor cell of the first MNO; iii) determining based on the measured signal characteristics whether the NSA 4G LTE anchor cell satisfies one or more reselection or handover criteria; iv) measuring one or more additional signal characteristics the NSA 5G cell of the first MNO associated with the NSA 4G LTE anchor cell; v) determining based on the measured additional signal characteristics whether the NSA 5G cell satisfies one or more additional reselection or handover criteria; and vi) refraining from sending, to the network element, a measurement report for the NSA 4G LTE anchor cell, when a) the NSA 4G LTE anchor cell does not satisfy the one or more reselection or handover criteria, b) the NSA 5G cell does not satisfy the one or more additional reselection or handover criteria, or c) the 5G-capable wireless device is engaged in a 4G LTE only service, or any combination thereof. In some embodiments, the apparatus is further configured to send, to the network element, the measurement report for the NSA 4G LTE anchor cell when a) the NSA 4G LTE anchor cell satisfies the one or more reselection or handover criteria, b) the NSA 5G cell satisfies the one or more additional reselection or handover criteria, and c) the 5G-capable wireless device is not engaged in a 4G LTE only service.

### Representative Exemplary Apparatus

FIG. 9 illustrates in block diagram format an exemplary computing device 900 that can be used to implement the various components and techniques described herein, according to some embodiments. In particular, the detailed view of the exemplary computing device 900 illustrates various components that can be included in the mobile wireless device 102. As shown in FIG. 9, the computing device 900 can include one or more processors 902 that represent microprocessors or controllers for controlling the overall operation of computing device 900. In some embodiments, the computing device 900 can also include a user input device 908 that allows a user of the computing device 900 to interact with the computing device 900. For example, in some embodiments, the user input device 908 can take a variety of forms, such as a button, keypad, dial, touch screen, audio input interface, visual/image capture input interface, input in the form of sensor data, etc. In some embodiments, the computing device 900 can include a display 910 (screen display) that can be controlled by the processor(s) 902 to display information to the user (for example, information relating to incoming, outgoing, or active communication sessions). A data bus 916 can facilitate data transfer between at least a storage device 940, the processor(s) 902, and a controller 913. The controller 913 can be used to interface with and control different equipment through an equipment control bus 914. The computing device 900 can also include a network/bus interface 911 that couples to a data link 912. In the case of a wireless connection, the network/bus interface 911 can include wireless circuitry, such as a wireless transceiver and/or baseband processor. The computing device 900 can also include a secure element 924. The secure element 924 can include an eUICC 108.

The computing device 900 also includes a storage device 940, which can include a single storage or a plurality of storages (e.g., hard drives), and includes a storage management module that manages one or more partitions within the storage device 940. In some embodiments, storage device 940 can include flash memory, semiconductor (solid state) memory or the like. The computing device 900 can also include a Random-Access Memory (RAM) 920 and a Read-Only Memory (ROM) 922. The ROM 922 can store programs, utilities or processes to be executed in a non-volatile manner. The RAM 920 can provide volatile data storage, and stores instructions related to the operation of the computing device 900.

### Wireless Terminology

In accordance with various embodiments described herein, the terms “wireless communication device,” “wireless device,” “mobile device,” “mobile station,” and “user equipment” (UE) may be used interchangeably herein to describe one or more common consumer electronic devices that may be capable of performing procedures associated with various embodiments of the disclosure. In accordance with various implementations, any one of these consumer electronic devices may relate to: a cellular phone or a smart phone, a tablet computer, a laptop computer, a notebook computer, a personal computer, a netbook computer, a media player device, an electronic book device, a MiFi® device, a wearable computing device, as well as any other type of electronic computing device having wireless communication capability that can include communication via one or more wireless communication protocols such as used for communication on: a wireless wide area network (WWAN), a wireless metro area network (WMAN) a wireless local area network (WLAN), a wireless personal area network (WPAN), a near field communication (NFC), a cellular wireless network, a fourth generation (4G) LTE, LTE Advanced (LTE-A), and/or 5G or other present or future developed advanced cellular wireless networks.

The wireless communication device, in some embodiments, can also operate as part of a wireless communication system, which can include a set of client devices, which can also be referred to as stations, client wireless devices, or client wireless communication devices, interconnected to an access point (AP), e.g., as part of a WLAN, and/or to each other, e.g., as part of a WPAN and/or an “ad hoc” wireless network. In some embodiments, the client device can be any wireless communication device that is capable of communicating via a WLAN technology, e.g., in accordance with a wireless local area network communication protocol. In some embodiments, the WLAN technology can include a Wi-Fi (or more generically a WLAN) wireless communication subsystem or radio, the Wi-Fi radio can implement an Institute of Electrical and Electronics Engineers (IEEE) 802.11 technology, such as one or more of: IEEE 802.11a; IEEE 802.11b; IEEE 802.11g; IEEE 802.11-2007; IEEE 802.11n; IEEE 802.11-2012; IEEE 802.11ac; or other present or future developed IEEE 802.11 technologies.

Additionally, it should be understood that the UEs described herein may be configured as multi-mode wireless communication devices that are also capable of communicating via different third generation (3G) and/or second generation (2G) RATs. In these scenarios, a multi-mode user equipment (UE) can be configured to prefer attachment to LTE networks offering faster data rate throughput, as compared to other 3G legacy networks offering lower data rate throughputs. For instance, in some implementations, a multi-mode UE may be configured to fall back to a 3G legacy network, e.g., an Evolved High Speed Packet Access (HSPA+) network or a Code Division Multiple Access (CDMA) 2000 Evolution-Data Only (EV-DO) network, when LTE and LTE-A networks are otherwise unavailable.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

The various aspects, embodiments, implementations or features of the described embodiments can be used separately or in any combination. Various aspects of the described embodiments can be implemented by software, hardware or a combination of hardware and software. The described embodiments can also be embodied as computer readable code on a non-transitory computer readable medium. The non-transitory computer readable medium is any data storage device that can store data which can thereafter be read by a computer system. Examples of the non-transitory computer readable medium include read-only memory, random-access memory, CD-ROMs, HDDs, DVDs, magnetic tape, and optical data storage devices. The non-transitory computer readable medium can also be distributed over network-coupled computer systems so that the computer readable code is stored and executed in a distributed fashion.

The foregoing description, for purposes of explanation, used specific nomenclature to provide a thorough understanding of the described embodiments. However, it will be apparent to one skilled in the art that the specific details are not required in order to practice the described embodiments. Thus, the foregoing descriptions of specific embodiments are presented for purposes of illustration and description. They are not intended to be exhaustive or to limit the described embodiments to the precise forms disclosed. It will be apparent to one of ordinary skill in the art that many modifications and variations are possible in view of the above teachings.

What is claimed is:

1. A method for controlling access to fifth generation (5G) cellular baseband resources of a first mobile network operator (MNO), the method comprising:
by a 5G-capable wireless device of a second MNO:
while connected to or camped on a legacy fourth generation (4G) long term evolution (LTE) cell of the second MNO:
receiving, from a network element, a control message indicating a non-standalone (NSA) 4G LTE anchor cell of the first MNO for which to perform measurements for reselection or handover, the NSA 4G LTE anchor cell associated with an NSA 5G cell of the first MNO;
measuring one or more signal characteristics of the NSA 4G LTE anchor cell of the first MNO;
determining based on the measured one or more signal characteristics whether the NSA 4G LTE anchor cell satisfies one or more reselection or handover criteria;
measuring one or more additional signal characteristics the NSA 5G cell of the first MNO associated with the NSA 4G LTE anchor cell;
determining based on the measured one or more additional signal characteristics whether the NSA 5G cell satisfies one or more additional reselection or handover criteria; and
refraining from sending, to the network element, a measurement report for the NSA 4G LTE anchor cell when i) the NSA 4G LTE anchor cell does not satisfy the one or more reselection or handover criteria, ii) the NSA 5G cell does not satisfy the one or more additional reselection or handover criteria, or iii) the 5G-capable wireless device is engaged in a 4G LTE only service, or any combination thereof.

2. The method of claim 1, further comprising:
by the 5G-capable wireless device of the second MNO:
sending, to the network element, the measurement report when i) the NSA 4G LTE anchor cell satisfies the one or more reselection or handover criteria, ii) the NSA 5G cell satisfies the one or more additional reselection or handover criteria, and iii) the 5G-capable wireless device is not engaged in a 4G LTE only service;
receiving, from the network element responsive to the measurement report, a second control message directing the 5G-capable wireless device to reselect or handover to the NSA 4G LTE anchor cell; and
reselecting or performing a handover procedure to transfer from the legacy 4G LTE cell of the second MNO to the NSA 4G LTE anchor cell of the first MNO.

3. The method of claim 1, wherein the 5G-capable wireless device of the second MNO is engaged in a 4G LTE only service while connected on an active voice over LTE (VOLTE) call.

4. The method of claim 1, further comprising:
by the 5G-capable wireless device of the second MNO:
receiving, from a second network element, a broadcast message indicating the NSA 4G LTE anchor cell is configured to share access with the second MNO.

5. The method of claim 1, further comprising:
by the 5G-capable wireless device of the second MNO:
receiving, from the network element, a second control message indicating a radio frequency of the NSA 5G cell.

6. The method of claim 1, further comprising:
by the 5G-capable wireless device of the second MNO:
maintaining a database of NSA 4G LTE anchor cells in local storage of the 5G-capable wireless device; and
updating a record time for a particular NSA 4G LTE anchor cell included in the database, the record time indicating a most recent time that the 5G-capable wireless device disconnected from or reselected away from the particular NSA 4G LTE anchor cell.

7. The method of claim 6, further comprising:
by the 5G-capable wireless device of the second MNO:
adding an entry for an additional NSA 4G LTE anchor cell to the database when not already included in response to receipt of i) a broadcast message indicating the additional NSA 4G LTE anchor cell is configured to share access with the second MNO and of ii) a second control message indicating a radio frequency of an additional NSA 5G cell associated with the additional NSA 4G LTE anchor cell.

8. The method of claim 6, wherein the database includes for each entry one or more fields storing values including: i) a public land mobile network (PLMN) value, ii) a tracking area code (TAC) value, iii) an evolved universal evolved mobile telecommunications system (UMTS) terrestrial radio access (E-UTRA) absolute radio frequency channel number (EARFCN) value, iv) a physical cell identifier (PCI), v) a cell global identity (CGI), vi) a related NSA 5G cell radio frequency, and vii) the record time for the associated NSA 4G LTE anchor cell.

9. The method of claim 6, further comprising:
by the 5G-capable wireless device of the second MNO:
deleting an entry for an associated NSA 4G LTE anchor cell from the database when a current time minus the record time for the associated NSA 4G LTE anchor cell exceeds a lifetime threshold value.

10. The method of claim 9, wherein the lifetime threshold value is based at least in part on a mobility state of the 5G-capable wireless device of the second MNO.

11. The method of claim 10, wherein the 5G-capable wireless device of the second MNO adjusts the lifetime threshold value to a lower value when the 5G-capable wireless device of the second MNO is moving and to a higher value when the 5G-capable wireless device of the second MNO is stationary.

12. An apparatus configurable for operation in a 5G-capable wireless device of a second mobile network operator (MNO), the apparatus comprising one or more processors coupled to a memory storing instructions that, when executed by the one or more processors, cause the 5G-capable wireless device of the second MNO to perform actions for controlling access to fifth generation (5G) cellular baseband resources of a first MNO, the actions including:
while connected to or camped on a legacy fourth generation (4G) long term evolution (LTE) cell of the second MNO:
receiving, from a network element, a control message indicating a non-standalone (NSA) 4G LTE anchor cell of the first MNO for which to perform measurements for reselection or handover, the NSA 4G LTE anchor cell associated with an NSA 5G cell of the first MNO;
measuring one or more signal characteristics of the NSA 4G LTE anchor cell of the first MNO;
determining based on the measured one or more signal characteristics whether the NSA 4G LTE anchor cell satisfies one or more reselection or handover criteria;
measuring one or more additional signal characteristics the NSA 5G cell of the first MNO associated with the NSA 4G LTE anchor cell;
determining based on the measured one or more additional signal characteristics whether the NSA 5G cell satisfies one or more additional reselection or handover criteria; and
refraining from sending, to the network element, a measurement report for the NSA 4G LTE anchor cell when i) the NSA 4G LTE anchor cell does not satisfy the one or more reselection or handover criteria, ii) the NSA 5G cell does not satisfy the one or more additional reselection or handover criteria, or iii) the 5G-capable wireless device is engaged in a 4G LTE only service, or any combination thereof.

13. The apparatus of claim 12, wherein the actions performed by the 5G-capable wireless device of the second MNO further comprise:
sending, to the network element, the measurement report when i) the NSA 4G LTE anchor cell satisfies the one or more reselection or handover criteria, ii) the NSA 5G cell satisfies the one or more additional reselection or handover criteria, and iii) the 5G-capable wireless device is not engaged in a 4G LTE only service;
receiving, from the network element responsive to the measurement report, a second control message directing the 5G-capable wireless device to reselect or handover to the NSA 4G LTE anchor cell; and
reselecting or performing a handover procedure to transfer from the legacy 4G LTE cell of the second MNO to the NSA 4G LTE anchor cell of the first MNO.

14. The apparatus of claim 12, wherein the actions performed by the 5G-capable wireless device of the second MNO further comprise:
receiving, from a second network element, a broadcast message indicating the NSA 4G LTE anchor cell is configured to share access with the second MNO.

15. The apparatus of claim 12, wherein the actions performed by the 5G-capable wireless device of the second MNO further comprise:
receiving, from the network element, a second control message indicating a radio frequency of the NSA 5G cell.

16. The apparatus of claim 12, wherein the actions performed by the 5G-capable wireless device of the second MNO further comprise:
maintaining a database of NSA 4G LTE anchor cells in local storage of the 5G-capable wireless device; and
updating a record time for a particular NSA 4G LTE anchor cell included in the database, the record time indicating a most recent time that the 5G-capable wireless device disconnected from or de-camped from the particular NSA 4G LTE anchor cell.

17. The apparatus of claim 16, wherein the actions performed by the 5G-capable wireless device of the second MNO further comprise:
adding an entry for an additional NSA 4G LTE anchor cell to the database when not already included in response to receipt of i) a broadcast message indicating the additional NSA 4G LTE anchor cell is configured to share access with the second MNO and of ii) a second control message indicating a radio frequency of an additional NSA 5G cell associated with the additional NSA 4G LTE anchor cell.

18. The apparatus of claim 16, wherein the database includes for each entry one or more fields storing values including: i) a public land mobile network (PLMN) value, ii) a tracking area code (TAC) value, iii) an evolved universal evolved mobile telecommunications system (UMTS) terrestrial radio access (E-UTRA) absolute radio frequency channel number (EARFCN) value, iv) a physical cell identifier (PCI), v) a cell global identity (CGI), vi) a related NSA 5G cell radio frequency, and vii) the record time for the associated NSA 4G LTE anchor cell.

19. The apparatus of claim 16, wherein the actions performed by the 5G-capable wireless device of the second MNO further comprise:
deleting an entry for an associated NSA 4G LTE anchor cell from the database when a current time minus the record time for the associated NSA 4G LTE anchor cell exceeds a lifetime threshold value.

20. A 5G-capable wireless device of a second mobile network operator (MNO), the 5G-capable wireless device of the second MNO comprising:
wireless circuitry comprising one or more antennas;
at least one processor communicatively coupled to the wireless circuitry and to memory storing instructions that when executed by the at least one processor cause the 5G-capable wireless device of the second MNO to perform actions for controlling access to fifth generation (5G) cellular baseband resources of a first MNO, the actions including:
while connected to or camped on a legacy fourth generation (4G) long term evolution (LTE) cell of the second MNO:
receiving, from a network element, a control message indicating a non-standalone (NSA) 4G LTE anchor cell of the first MNO for which to perform measurements for reselection or handover, the NSA 4G LTE anchor cell associated with an NSA 5G cell of the first MNO;
measuring one or more signal characteristics of the NSA 4G LTE anchor cell of the first MNO;
determining based on the measured one or more signal characteristics whether the NSA 4G LTE anchor cell satisfies one or more reselection or handover criteria;
measuring one or more additional signal characteristics the NSA 5G cell of the first MNO associated with the NSA 4G LTE anchor cell;
determining based on the measured one or more additional signal characteristics whether the NSA 5G cell satisfies one or more additional reselection or handover criteria; and
refraining from sending, to the network element, a measurement report for the NSA 4G LTE anchor cell when i) the NSA 4G LTE anchor cell does not satisfy the one or more reselection or handover criteria, ii) the NSA 5G cell does not satisfy the one or more additional reselection or handover criteria, or iii) the 5G-capable wireless device is engaged in a 4G LTE only service, or any combination thereof.
